(19) United States
(12) Patent Application Publication
(10) Pub. No.: US 2008/0159384 A1
(43) Pub. Date: Jul. 3, 2008

(54) SYSTEM AND METHOD FOR JITTER BUFFER REDUCTION IN SCALABLE CODING

(76) Inventors: Reha Civanlar, Palo Alto, CA (US); Alexandros Eleftheriadis, Tenafly, NJ (US); Ofer Shapiro, Fair Lawn, NJ (US)

Correspondence Address: BAKER BOTTS L.L.P., 30 ROCKEFELLER PLAZA, 44TH FLOOR, NEW YORK, NY, 10112-4498, US

(21) Appl. No.: 12/015,963

(22) Filed: Jan. 17, 2008

Related U.S. Application Data
(63) Continuation of application No. PCT/US2006/028368, filed on Jul. 20, 2006.
(60) Provisional application No. 60/701,110, filed on Jul. 20, 2005.

(51) Int. Cl. H04B 1/66

(52) U.S. Cl. 375/240.01

(57) ABSTRACT

Jitter buffer arrangements for video and audio communications networks include a plurality of jitter buffers each of which is designated to buffer a particular layer scalably coded data streams, and coupled decoder to decode the received scalably coded data stream layer-by-layer.

### CROSS-REFERENCE TO RELATED APPLICATIONS

This application claims the benefit of U.S. provisional patent application Ser. No. 60/701,110 filed Jul. 20, 2005. Further, this application is related to co-filed United States patent application Serial Nos. [SVCSystem], [SVC], and [base trunk]. All of the aforementioned priority and related applications are hereby incorporated by reference herein in their entireties.

### FIELD OF THE INVENTION

The present invention relates to multimedia and telecommunications technology. In particular, the present invention relates to audio and video data communication systems and specifically to the use of jitter buffers in video encoding/decoding systems.

### BACKGROUND OF THE INVENTION

Data packets/signals (e.g., audio and video signals) transmitted across conventional electronic communication networks (e.g., Internet Protocol (“IP”) networks) are subject to undesirable phenomena, which degrade signal integrity or quality. The undesirable phenomena include, for example, variable delay (i.e., each data packet may suffer a different delay, also known as “jitter”), out-of-order reception of sequential packets, and packet loss.

In conventional streaming video systems, a network device typically receives multimedia or video packets from a network and stores the packets in a buffer. The buffer allows enough time for out-of-order or delayed packets to arrive. The buffer then may release or feed multimedia/video data at a uniform rate for playback. If a specific data frame is carried in more than one packet, the buffer must allocate sufficient time for all the parts of a particular frame to arrive. Jitter buffers lengths/delays can account for a major part of the overall end-to-end delay in an IP communication system.

Traditionally, a jitter buffer's length (i.e., delay) is adjusted to allow almost all fragments of a frame sufficient time to arrive before the next frame has to be decoded for display.

Scalable coding techniques allow a data signal (e.g., audio and/or video data signals) to be coded and compressed for transmission in a multiple-layer format. The information content of a subject data signal is distributed amongst all of the coded multiple layers. Each of the multiple layers or combinations of the layers may be transmitted in respective bitstreams. A “base layer” bitstream, by design, may carry sufficient information for a desired minimum or basic quality level reconstruction, upon decoding, of the original audio and/or video signal. Other “enhancement layer” bitstreams may carry additional information, which can be used to improve upon the basic level quality reconstruction of the original audio and/or video signal.

Scalable audio coding (SAC) and video coding (SVC) may be used in audio and/or videoconferencing systems implemented over electronic communications networks. Co-filed United States patent application Serial Nos. [SVCSystem] and [SVC] describe systems and methods for scalable audio and video coding for exemplary audio and/or videoconferencing applications. The referenced patents describe particular IP multipoint control units (MCUs), Scalable Audio Conferencing Servers (SACS) and Scalable Video Conferencing Servers (SVCS) that are designed for mediating the transmission of SAC and SVC layer bitstreams between conferencing endpoints.

It should be noted that other methods of creating enhancement layers also include: a) complete representation of the high quality signal, without reference to the base layer information, a method also known as ‘simulcasting’; or b) two or more representations of the same signal in similar quality but with minimal correlation, where a sub-set of the representations on its own would be considered ‘base layer’ and the remaining representations would be considered an enhancement. This latter method is also known as ‘multiple description coding’. For brevity all these methods are referred to herein as base and enhancement layer coding.

Consideration is now being given to improving the design of jitter buffers used in video communication systems. In particular, attention is being directed to designing efficient jitter buffers in communication systems that transmit scalable coded video streams.

### SUMMARY OF THE INVENTION

Systems and methods are provided for reducing jitter buffer lengths or delays in video communication systems that transmit scalable coded video streams.

The systems and methods of the present invention generally involve deploying a plurality of jitter buffers at receivers/endpoints to separately buffer two or more layers of a received SVC stream. Further, the plurality of jitter buffers may be configured with different delay settings to accommodate, for example, different loss rates of the individual layer streams.

In an exemplary embodiment of the present invention, a system for receiving SVC data (e.g., a receiving terminal or endpoint) includes a number of jitter buffers, each of which is designated to buffer a respective one of the layers of a received SVC data stream. The jitter buffers are configured with different lengths/delays in a manner which reduces the delay for the overall system. The receiving terminal/endpoint also includes a decoder that can decode the buffered video data stream layer by layer. The decoder is configured to selectively drop enhancement layer information in a manner which has with minimal impact on displayed video quality but which improves system delay performance.

### BRIEF DESCRIPTION OF THE DRAWINGS

FIGS. 1A and 1B are block diagrams illustrating exemplary scalably coded video data receivers, which include jitter buffer arrangements designed in accordance with the principles of the present invention.

FIGS. 2 and 3 are error rate graphs, which illustrate the advantages of the jitter buffer arrangements of the present invention.

Throughout the figures, the same reference numerals and characters, unless otherwise stated, are used to denote like features, elements, components or portions of the illustrated embodiments. Moreover, while the present invention will now be described in detail with reference to the figures, it is done so in connection with the illustrative embodiments.

### DETAILED DESCRIPTION OF THE INVENTION

Jitter buffer arrangements that are designed to reduce delay in video communication systems are provided. The jitter buffer arrangements may be implemented at video-receiving terminals or communications system endpoints that receive video data streams encoded in multi-layer format, such as scalable coding with a base and enhancement layer. It should be noted that other methods of creating enhancement layers also include simulcasting and multiple description coding, among others, and. for brevity we refer to herein all these methods as base and enhancement layer coding.

The jitter buffer arrangements include a plurality of individual jitter buffers, each of which is designated to buffer data packets for a particular layer (or a particular combination of layers) of an incoming video data stream. The jitter buffer arrangements further include or are associated with a decoder, which is designed to decode the buffered data packets individual jitter buffer by individual jitter buffer.

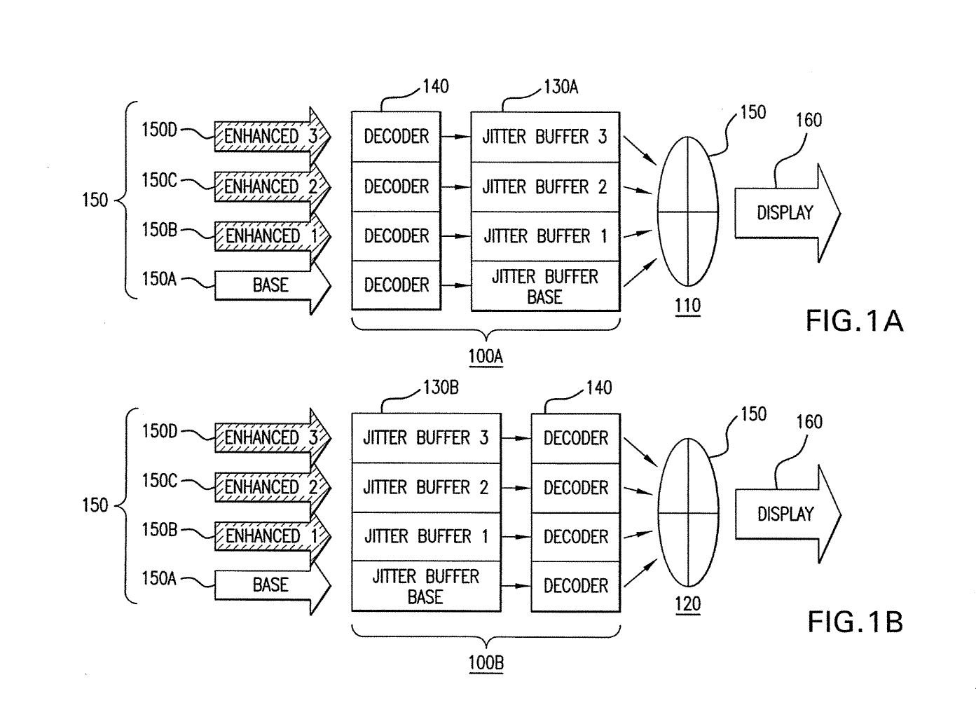

FIGS. 1A and 1B show exemplary jitter buffer/decoder arrangements 100A and 100B that may be incorporated in receiving terminals or endpoints (e.g., endpoints 110 and 120, respectively). Both arrangements 100A and 100B are designed to receive, decode, and display video data streams 150 that are scalably coded in a multi-layer format (e.g., as base layer 150A and enhancement layers 150B-D). Both arrangements include a plurality of jitter buffers 130 for buffering video packets in the incoming video data streams 150 layer-by-layer. Jitter buffers 130A and 130 as shown, for example, include a base jitter buffer corresponding to video stream base layer 150A, and jitter buffers 1, 2, and 3 corresponding to video stream enhancement layers 150B-150D, respectively. Both arrangements 100A and 100B include a decoder 140. In arrangement 100A, decoder 140 precedes jitter buffer 130A so that the incoming video stream layers 150A-D are decoded before buffering. Conversely, in arrangement 100B, decoder 140 succeeds jitter buffer 130B so that video stream layers 150A-D are buffered and then decoded. The outputs of arrangements 100A and 100B may be multiplexed by a multiplexer (e.g., MUX 150) to produce a reconstructed video stream 160 for display.

Further, endpoints 110/120 may include suitable jitter buffer management algorithms, which allow for different buffering or waiting times for base and enhancement layer video stream packets in their respective buffers. The distribution of the wait times (i.e. jitter buffer lengths/delays) for the different layers may be selected to minimize the overall delay in the system. For example, jitter buffer/decoder arrangements 100A and 100B may be configured to permit the tolerable error rates (i.e., the rate at which late-arriving packets are discarded or considered dropped by the jitter buffer) for the enhancement layers to be higher than the error rate allowed for the base layer. This scheme recognizes that in practice, base layer packets tend to be smaller than enhancement layer packets and are therefore less susceptible to jitter to begin with, and that the base layer packets are in most instances transmitted over better quality links or channels, which are less prone to packet loss and jitter.

The values of the jitter buffer lengths/delays and their distribution may be adjusted dynamically in response to network conditions (e.g., loss rates or traffic load) or any other factors.

The jitter buffer arrangements of the present invention can significantly reduce overall communication system delays before data contained in a received frame can be displayed or played back. Such reduced delays are desirable quality features in all audio and video communication systems, and particularly in systems operating in real-time such as videoconferencing or audio communications applications.

The jitter buffer arrangements of the present invention also advantageously allow the base and enhancement layers, which are buffered separately, to be decoded separately. Receiving endpoints 110/120 may begin decoding any of the base and enhancement layers without waiting for the other layers to arrive. This feature can reduce or minimize the amount of idle time for the decoding CPU or DSP (e.g., decoder 140), thereby increasing its overall utilization. This feature also facilitates the use of multiple CPUs or CPU cores.

In accordance with an exemplary embodiment of the present invention, different jitter buffers may be associated with each of the different quality layers in the video stream. Different values may be assigned to different jitter buffer delays or lengths in response to network conditions, so that the likelihood of the timely receipt of the base layer packets related to video frames is very high even as occasional losses of related enhancement layer packets are permitted or tolerated.

With renewed reference to FIGS. 1A and 1B, arrangement 100A includes a decoder 140, which decodes the incoming video stream layers 150A-1 SOB in parallel, and multiple jitter buffers 130A for buffering the respective decoded layer streams. In arrangement 100B, decoder 140 performs decoding of the layers, which processes are dependent on each other (i.e. a layer is required to decode another layer). In either arrangement, the operational parameters for a jitter buffer associated with a particular layer of video data may be different from the operational parameters used for the jitter buffers associated with other layers of video data. The operational parameters (e.g., delay or length settings) for the jitter buffers may be suitably selected or adjusted in response to network conditions or to address other concerns for the particular implementation.

An exemplary procedure for the selection and assignment of jitter buffer lengths/delays is described herein with reference to an exemplary video system B, which employs scalable video coding, and a contrasting video system A, which does not employ scalable video coding. In either system A or B, a number of transmitted data packets (e.g., three packets) may include all the information related to a given video frame. In system A, all of the transmitted packets are required to display the frame. Assuming that the packets related to the frame have equal but uncorrelated arrival probabilities, then the probability P of obtaining a correct display at a receiver is given by

P=(1−p)ⁿ

where p is the probability that a single packet related to the frame will arrive later than a certain jitter buffer delay d beyond which any late-arriving packets are presumed lost, and n is the number of packets needed for reconstructing the frame. In system A, the number n is the total number of transmitted packets related to the frame. In contrast, in system B, the number n is 1 (i.e., the base layer). Accordingly, the probability P that the frame will be displayed correctly in system B is the fraction (1−p), which is greater than (1−p)ⁿ—the probability that the frame will be displayed correctly in system A.

In a design procedure for the selection of suitable jitter buffer lengths/delays for system B, which employs scalable video coding, the probability p may be computed using the error function as a function of jitter buffer delay d under the assumption that the jitter statistics are Gaussian.

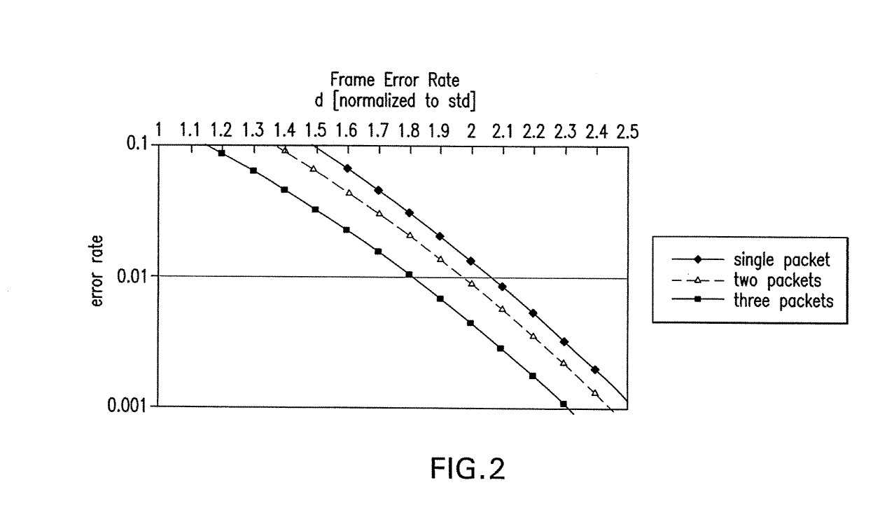

FIG. 2 shows exemplary computed error or frame drop rates (1−P) for a one to three packet video frame as a function of jitter buffer length/delay d, which is normalized by a suitable measure of jitter. The suitable measure of jitter is defined as one standard deviation of packet arrival delays in the network. As seen from FIG. 2, similar frame drop rates can be obtained for both systems A and B by setting the jitter buffer delay d for system B to about ⅓ standard deviation when in contrast the jitter buffer delay d for system A defined above is set at about 1 standard deviation. The similar frame drop rates are obtained in the two systems because system A must wait for receipt of all three packets for proper frame reconstruction and display, while system B, which tolerates loss of enhancement packets, has to wait only for receipt of the base layer. Thus, if system A shows ajitter of 30 ms, approximately 10 ms of that delay is removed in system B.

The reconstruction and display of a video frames in System B without receipt of the enhancement layers is associated with a ‘resolution drop rate’ (i.e., when base layer packets arrive on time, but enhancement packets arrive late). With reference to FIG. 2, assuming that an acceptable base layer drop rate is set at 1%, the resolution drop rate is also at most a few percentage points.

In another exemplary implementation of present invention, in response to network conditions, different lengths/delays may be assigned to the different jitter buffers associated with base layer and enhancement layers, respectively. For simplicity in description herein, for example, the base layer frame is assumed to be included in one packet, and all enhancement layer frames are assumed to be included as a frame in a second packet so that there is one corresponding base layer jitter buffer and one corresponding enhancement layer buffer only. In this example, the base layer jitter buffer length may be configured to drop no data or at most a negligible amount of data from the base layer (i.e., to achieve a near zero frame drop rate), which results in acceptable system performance on resolution drop rates. The length/delay for the enhancement layer jitter buffer may be set at twice that for the base layer jitter buffer.

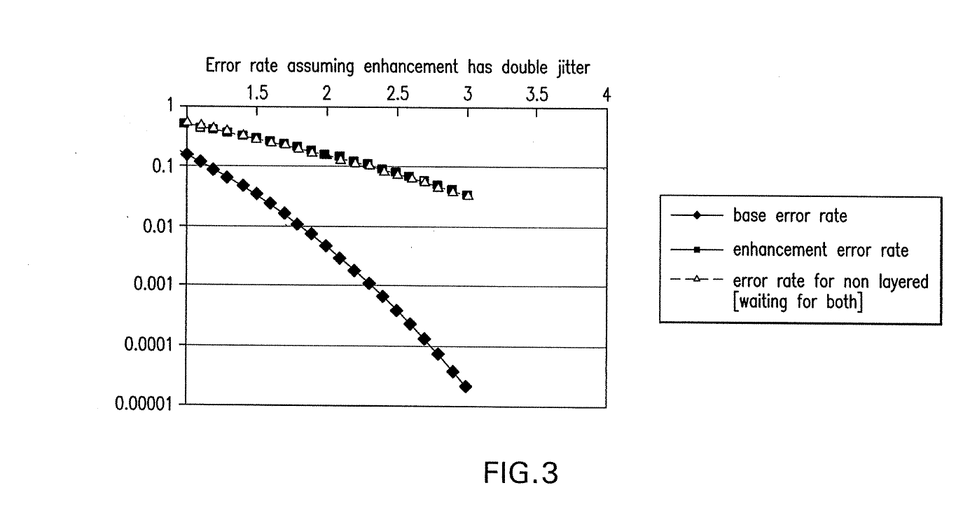

Further in this example, the frame drop rates are the same as the packet drop rates as one frame of base or enhancement layer is included in one packet. FIG. 3 is graph, which shows computed frame drop rates as a function of d (normalized to base jitter) for different base and enhancement layer combination scenarios.

As seen from FIG. 3, a normalized jitter buffer length/delay ratio of about 2.7 corresponds to 1×10⁻⁴ base layer drop rate (e.g., 1 frame dropped every 300 seconds in a 1-3 packet frame configuration). To obtain the same low error rate in non-layered systems or systems in which the jitter buffer lengths are the same for both base and enhancement layers, the total jitter buffer length/delay would have to be at least double to accommodate the enhancement layer jitter which in this example is twice the base layer jitter. The exemplary implementation of the present invention avoids the introduction of this additional double delay in the video display.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention. For example, the inventive jitter buffer arrangements have been described herein with reference to video data streams encoded in multi-layer format. However, it is readily understood that the inventive jitter buffer arrangements also can be implemented for audio data streams encoded in multi-layer format.

It also will be understood that in accordance with the present invention, the jitter buffer and decoder arrangements can be implemented using any suitable combination of hardware and software. The software (i.e., instructions) for implementing and operating the aforementioned jitter buffer and decoder arrangements can be provided on computer-readable media, which can include without limitation, firmware, microcontrollers, microprocessors, integrated circuits, ASICS, on-line downloadable media, and other available media.

1. A jitter buffer arrangement for a receiving endpoint in an electronic communications network, the arrangement comprising:
a plurality of jitter buffers wherein each jitter buffer is designated to buffer a particular layer of a received scalably coded data stream, and
a decoder coupled to the plurality of jitter buffers, wherein the decoder is configured to decode the received scalably coded data stream layer-by-layer.

2. The jitter buffer arrangement of claim 1 wherein the scalably coded data stream comprises at least one of a video data stream, an audio data stream or a combination thereof.

3. The jitter buffer arrangement of claim 1 wherein the plurality of jitter buffers precedes the decoder.

4. The jitter buffer arrangement of claim 1 wherein the plurality of jitter buffers succeeds the decoder and buffers the decoder output layer-by-layer.

5. The jitter buffer arrangement of claim 1 wherein the plurality of jitter buffers each has a design length, and wherein at least two jitter buffers have different design lengths.

6. The jitter buffer arrangement of claim 1 wherein the plurality of jitter buffers each has a length, which is adjusted dynamically in response to network conditions.

7. The jitter buffer arrangement of claim 1 wherein a first and second jitter buffers are designated to buffer a base layer and an enhancement layer, respectively.

8. The jitter buffer arrangement of claim 7 wherein the design lengths of the first and second jitter buffers are based on a statistical estimate of jitter in video streams received over the network.

9. The jitter buffer arrangement of claim 7 wherein the design length of the first buffer is a fraction of the design length of the second jitter buffer.

10. A method for managing jitter buffer delay at a receiving endpoint in an electronic communications network, the method comprising:
providing a plurality of jitter buffers, wherein each jitter buffer is designated to buffer a particular layer of a received scalably coded data stream, and
coupling a decoder to the plurality of jitter buffers, wherein the decoder is configured to decode the received scalably coded data stream layer-by-layer.

11. The method of claim 10 wherein the scalably coded data stream comprises at least one of a video data stream, an audio data stream and a combination thereof.

12. The method of claim 10 wherein the plurality of jitter buffers precedes the coupled decoder.

13. The method of claim 10 wherein the plurality of jitter buffers succeeds the coupled decoder, the method further comprising buffering the decoder output layer-by-layer.

14. The method of claim 10 wherein providing a plurality of jitter buffers comprises providing a plurality of jitter buffers each having a design length, and wherein at least two jitter buffers have different design lengths.

15. The method of claim 10 wherein providing a plurality of jitter buffers comprises providing a plurality of jitter buffers each having a design length, and further comprises adjusting the design lengths dynamically in response to network conditions.

16. The method of claim 10 wherein providing a plurality of jitter buffers comprises providing a first and a second jitter buffer designated to buffer a base layer and an enhancement layer, respectively.

17. The method of claim 16 further comprising assigning the design lengths for the jitter buffers based on a statistical estimate of jitter in transmitted video streams on the network.

18. The method of claim 16 further comprising assigning a design length to the first buffer, which is a fraction of the design length assigned to the second jitter buffer.

19. Computer readable media comprising a set of instructions to perform the steps recited in at least one of claims 10-18.
